(19) United States
(12) Patent Application Publication
(10) Pub. No.: US 2020/0288107 A1
(43) Pub. Date: Sep. 10, 2020

(54) SYSTEMS, METHODS AND APPARATUS FOR GENERATING A GHOST IMAGE REPRESENTATION

(71) Applicant: Government of the United States, as represented by Secretary of the Air Force, Wright-Patterson AFB, OH (US)

(72) Inventor: Joshua Hendrickson, Dayton, OH (US)

(21) Appl. No.: 16/296,466

(22) Filed: Mar. 8, 2019

(51) Int. Cl. H04N 13/275; G06T 19/20; G06F 9/30

(52) U.S. Cl. CPC H04N 13/275; G06T 2219/2021; G06F 9/3004; G06T 19/20

(57) ABSTRACT

A system, method and apparatus for a ghost imager having spatial imaging and high-resolution spectral information of the imaged object. This obviates the lack of spectral content within images obtained via ghost imaging.

### STATEMENT OF GOVERNMENT INTEREST

The invention described herein may be manufactured and used by or for the Government of the United States for all governmental purposes without the payment of any royalty.

### INCORPORATION BY REFERENCE

This application incorporates by reference, in its entirety, U.S. Pat. No. 6,061,551, “Method and System for Down-converting Electromagnetic Signals” to David F. Sorrells et al. and U.S. Pat. No. 6,061,555, “Method and System for Ensuring Reception of a Communication Signal” to Michael Bultman et al., both of which are hereby incorporated by reference in their entirety herein.

### FIELD OF THE DISCLOSURE

This invention relates to generating a ghost image representation that includes utilizing frequency combs as the light source.

### BACKGROUND OF THE DISCLOSURE

Conventional techniques for ascertaining spectroscopic properties of materials typically rely on directing non-entangled (random) photons at a material, which absorbs the photons and emits fluorescence. In general, these conventional techniques rely on varying the frequency of the non-entangled photons. By comparing incident photon energy with the energy of resulting fluoro-photons, the absorbing material may be crudely characterized.

Although frequency combs can be useful for obtaining spectral characteristics for a target, the ability to spatially resolve different portions of the target are dictated by the size of the target that is illuminated by the frequency combs, and/or the detector dimensions and optical imaging elements used. Thus, in order to obtain a spatially separated image of a target, it is desirable to spatially scan the frequency comb over the target to obtain individual spectral details for each spatial component. However, spatially scanning the frequency comb undesirably adds to the complexity and size of a frequency comb spectrometer.

### BRIEF SUMMARY OF THE DISCLOSURE

It will be understood that the invention is not limited to the embodiments described herein. To the contrary, it includes all alternatives, modifications, and equivalents as may be included within the spirit and scope.

Embodiments of the present invention are directed to systems, methods and apparatus for providing improved ghost imaging, or a representation of a ghost image.

One embodiment of the invention is directed to an apparatus that includes a light source configured to provide a first set of light rays to a first detector and a second set of light rays to a second detector. The first detector is configured to measure signals that result from the first set of light rays interacting with an object and generate first detector data; and the second detector configured to receive the second set of light rays that are separate from the object and generate second detector data. The first detector data and the second detector data are utilized to generate a representation of the object.

### BRIEF DESCRIPTION OF THE DRAWINGS

The accompanying drawings, which are incorporated in and constitute a part of this specification, illustrate embodiments of the present invention and, together with a general description given above, and the detailed description given below, explain the principles of the present invention.

FIGS. 1A, 1B and 1C show three embodiments of an apparatus according to this invention.

FIGS. 2A and 2B show graphs of frequency combs.

FIG. 3 shows a series of steps according to an embodiment described herein.

FIG. 4 shows a processing apparatus according to an embodiment of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate properties and advantages of some of the embodiments of the present invention. Furthermore, these are examples of reduction to practice of the present embodiments and confirmation that the principles described in the present disclosure are therefore valid but should not be construed as in any way limiting the scope of the invention.

Although the following detailed description contains many specifics for the purposes of illustration, anyone of ordinary skill in the art will appreciate that many variations and alterations to the following details are within the scope of the invention. Accordingly, the following embodiments are set forth without any loss of generality to, and without imposing limitations upon, the claims.

In this detailed description, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Unless stated otherwise, terms such as “first” and “second” are used to arbitrarily distinguish between the elements such terms describe. Thus, these terms are not necessarily intended to indicate temporal or other prioritization of such elements.

Furthermore, in this detailed description, a person skilled in the art should note that quantitative qualifying terms such as “generally,” “substantially,” “mostly,” “approximately” and other terms are used, in general, to mean that the referred to object, characteristic, or quality constitutes a majority of the subject of the reference.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Uses for the embodiments described herein include chemical and biological sensing and/or imaging and/or generating a representation. Current methods include dual frequency comb spectroscopy which can give high precision spectral information but lack the low light level imaging capability of a ghost imager. Also, while optical resonators may be used for chemical or biological sensing, they have no imaging capability.

The embodiments described herein permit real time imaging of chemical and biological agents within the atmosphere with a high degree of spatial and spectral resolution in low light environments, such as single photon levels.

Embodiments described herein are directed to a design for a ghost imager that utilizes quantum entangled dual frequency combs as the light source. By incorporating a dual frequency comb source, the ghost imager simultaneously obtains high resolution spectroscopic information of an object. This allows for spectrally resolved remote sensing and imaging of chemical and biological agents in very low light level scenarios, such as single photon levels. The very low light levels are typically levels that are less than desirable for typical photographic imaging.

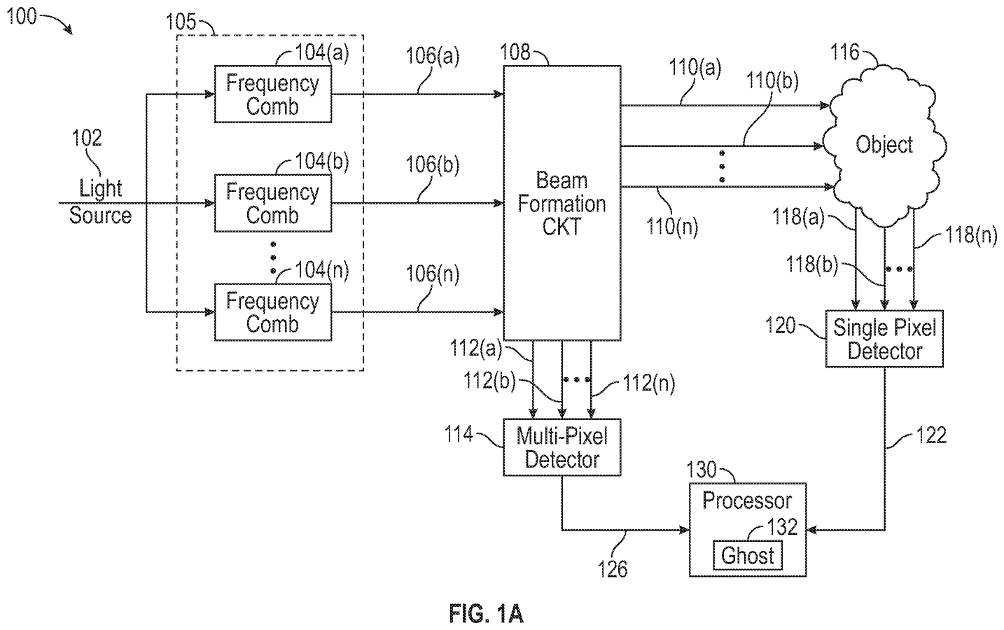

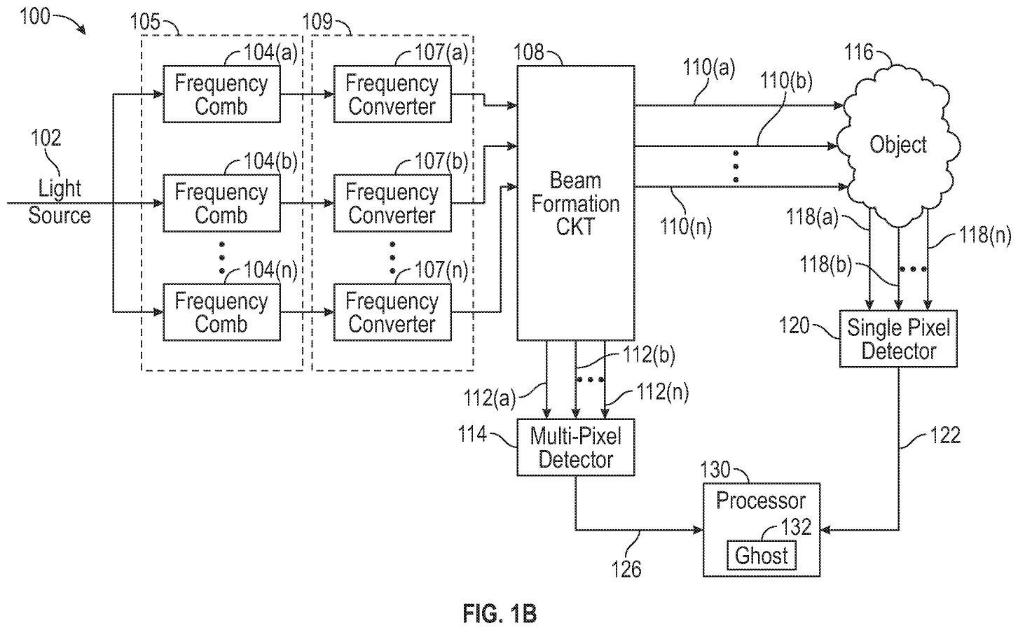

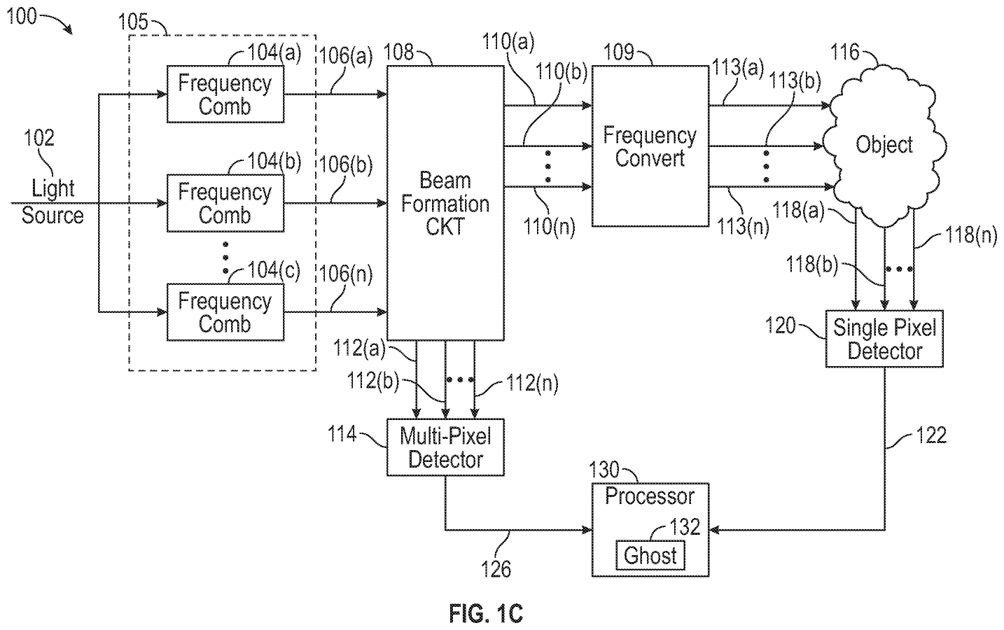

FIGS. 1A, 1B and 1C show three embodiments. FIG. 1A shows a frequency comb, FIG. 1B shows a frequency comb with an up/down converter circuit before the beam former module and FIG. 1C shows the up/down converter circuit after the beam is formed. Each of these embodiments are described herein in more detail.

The embodiments described may use more or fewer components as shown in the figures. For example, the apparatus shown in FIGS. 1A-1C may use a single up-converter circuit and/or a single down converter circuit and output one resultant signal from either the frequency combs or the converter circuit. Alternatively, each frequency comb may have an associated converter circuit and produce associated output signals from that converter circuit. The illustrations depicted herein are merely used to explain how the apparatus functions and any design modifications do not depart from the scope of this disclosure and/or the claims.

FIG. 1A shows a system 100 that comprises a light source 102, a plurality of frequency combs 104(a) . . . (n), a beam former, or beam formation circuit, 108, an object 116, a first detector 120, a second detector 114 and a processor 130.

The light source 102 may be an overlapping light source, which may comprise a laser source whose spectrum consists of a series of discrete, equally spaced frequency lines. The light 102 is provided to two or more optical frequency combs 104(a) . . . (n) where “n” is any suitable number, which may be collectively referred to in the singular as a frequency comb 105.

The number of frequency combs (generally 104) that form frequency comb 105 may be a design choice, based on the environment of use and other design parameters. Two or more frequency combs 104(a) . . . (n), may be combined into a single operational circuit 105. In an embodiment in which there are two frequency combs 104(a) and 104(b), the frequency comb 105 is a dual frequency comb. The frequency combs 104(a) . . . (n) (or dual frequency comb 105) can be generated by a number of mechanisms, including periodic modulation (in amplitude and/or phase) of a continuous-wave laser, four-wave mixing in nonlinear media, or stabilization of the pulse train generated by a mode-locked laser.

The frequency domain representation of a perfect frequency comb 105 is a series of delta functions spaced according to: fₙ=f₀+ηfᵣ

where η is an integer, fᵣ is the comb tooth spacing, and fₙ is the carrier offset frequency.

Dual comb spectroscopy (DCS) effectively maps the optical spectrum of width, Δv, to an rf spectrum of width, Δv/m, where m=fᵣ/Δfᵣ. Here, fᵣ is the comb repetition frequency and Δfᵣ is the repetition frequency difference between the two combs. Compression factors m of 30,000-1,000,000 are common, and several hundred thousand comb teeth, spanning tens to hundreds of THz, can be mapped into a 100 MHz rf band and digitized.

As described herein, embodiments may utilize a frequency comb (generally 104 which are collectively frequency comb 105), which may be an entangled dual frequency comb. Each frequency comb 104 provides a corresponding input 106(a), 106(b) . . . 106(n), where “n” is any suitable number to beam former, or beam formation circuit, 108. Beam former 108 may be a beam combiner or a beam splitter, depending on the desired performance and the type of input. The beam former circuit, or module, 108 provides a first set of rays 110(a) . . . (n) where “n” is any suitable number, collectively, the rays 110 are a first portion, or a first set, of rays.

The number of rays 110 provided to object 116 is the same as the number of frequency combs 104. Thus, a dual comb frequency having two frequency combs 104(a) and 104(b) will cause beam former 108 to provide two rays 110(a) and 110(b) to object 116. The beams generally 110 will interface with object 116 and rays 118(a) . . . (n) where “n” is any suitable number will be detected by single pixel detection unit 120. The detector 120, may be a single pixel “bucket” detector.

As described herein, the first detector 120 is capable of measuring a heterodyne radio-frequency signal to generate the first detector data.

The number of rays 118 will be the same number of rays 110. Thus, a dual comb frequency having two frequency combs 104(a) and 104(b) will cause beam former 108 to provide two rays 110(a) and (b) to object 116 and two rays 118(a) and 118(b) will be input to detector 120.

As stated above, the light source 102 is split, or combined, or formed, by beam formation circuit 108, in two portions: the first portion 110 interfaces, or interacts, with object 116; the second portion 112(a) . . . (n) where “n” is any suitable number, is provided to multi-pixel detector 114, which does not interact, or interface, with the object 116 to be represented, or imaged. The number of rays 112 will be the same as the number of rays 106. Thus, a dual comb frequency having two frequency combs 104(a) and 104(b) will cause beam former 108 to provide two rays 112(a) and 112(b) to be input to detector 114.

The rays 112 may be raster scanned across a multi-pixel detector 114, which may be a high-resolution camera.

Correlations between the two detectors 114 and 120 are provided to processor 130, as shown by 126 and 122, respectively. Processor 130 may be any computer, processing device, or module with sufficient processing speed and memory to accomplish the desired tasks. Processor 130 includes a ghost imager module 132, which generates a representation of the object 116, which may be a spatial image of the object 116. In one embodiment the ghost imager 132 is capable of simultaneously obtaining high precision spectroscopic information of the imaged object 116.

The use of computation methods to Fourier transform the temporal response of the single pixel detector 120, high resolution spectroscopic information is generated. The entangled dual frequency comb 105, upon splitting, or combining, can be up-converted or down-converted using nonlinear crystals in order to operate each arm of the ghost imager in a wavelength regime where the detector 114, which may be a camera, and single pixel detector 120 are most efficient.

The object 116 may be a chemical agent, molecular agent, biological agent or any object that is desired to be imaged.

FIG. 1B shows an embodiment that includes a frequency conversion circuit 109. The frequency conversion circuit 109 may comprise one or more frequency converters shown as 107(a) . . . (n) where “n” is any suitable number. The frequency conversion circuit 109 may comprise a frequency converter 107 for each frequency comb 104. Thus, in a dual comb frequency the frequency conversion circuit 109 may comprise two frequency converters 107(a) and 107(b), or the circuit 109 may perform up and/or down conversion for the frequency comb using more or fewer frequency converters 107 than there are frequency combs 104. The conversion circuit 109 provides an output that is input to beam formation module 108. Typically, the conversion circuit 109 will provide an input to beam formation module for each frequency comb 104.

The other elements of FIG. 1B have been described herein.

FIG. 1C shows an embodiment in which the up and/or down conversion is performed after the beam formation circuit 108 has combined the input from the frequency combs 104. In this embodiment the output from the beam formation circuit 108, shown as 110(a) . . . (n) where “n” is any suitable number are provided to an up/down conversion circuit 109. The frequency conversion circuit 109 provides signals 113(a) . . . (n) to object 116. In this embodiment the number of signals 113 provided to the object 116 from the up/down conversion unit 109 can be different that the number of frequency combs 104.

As shown in FIG. 1C, the up/down conversion unit 109 is in the arm of the object that is to be imaged. Alternatively, up/down conversion unit 109 could provide up/down converted signals to the multi-pixel detector 114.

The other elements of FIG. 1C have been described herein.

Alternatively, the beam formation circuit 108 could be a beam splitter that splits the input light into a desired number of portions.

Typically, the inputs to the processor 130, and ghost image processor 132, will preferably be at approximately the same time so that the ghost image processor 132 can build, or generate, the ghost image from both detector (114, 120) signals. In order to facilitate the ghost image generation, the processor 130 may include delay circuits, or delay loops, to modify the timing of the signals. This delay may include optical delay and/or electronic delay.

The embodiments described herein may be used in any area or field where high-resolution, KHz frequency resolution, spectroscopic information of an object is desired while simultaneously obtaining an image of the object.

Some advantages of the disclosed embodiments are that real time representations, images, or electronic data, corresponding to chemical and/or biological agents within the atmosphere can be obtained with a high degree of spatial and spectral resolution in low light environments.

Embodiments described herein relate to a design for a ghost imager 132, which utilizes quantum entangled dual frequency combs 104 as the light source 102. By incorporating a dual frequency comb source 104, the ghost imager 132 is capable of obtaining high resolution spectroscopic information. This allows for spectrally resolved remote sensing and generation of a representation, such as an image, of chemical and biological agents in very low light level scenarios. The representation may include imaging or electronic data, which may be stored on a non-volatile memory, or non-transitory memory, or other suitable data structure, which may be on a network.

The embodiments described herein are directed to a device that obtains high resolution spectroscopic information of an object. It comprises an entangled dual frequency comb 104 that acts as the light source for a ghost imager 132. Using computational techniques, such as Fourier transform, on the detected signal, which interacts, or interfaces, with the object of interest, high spectral resolution is obtained.

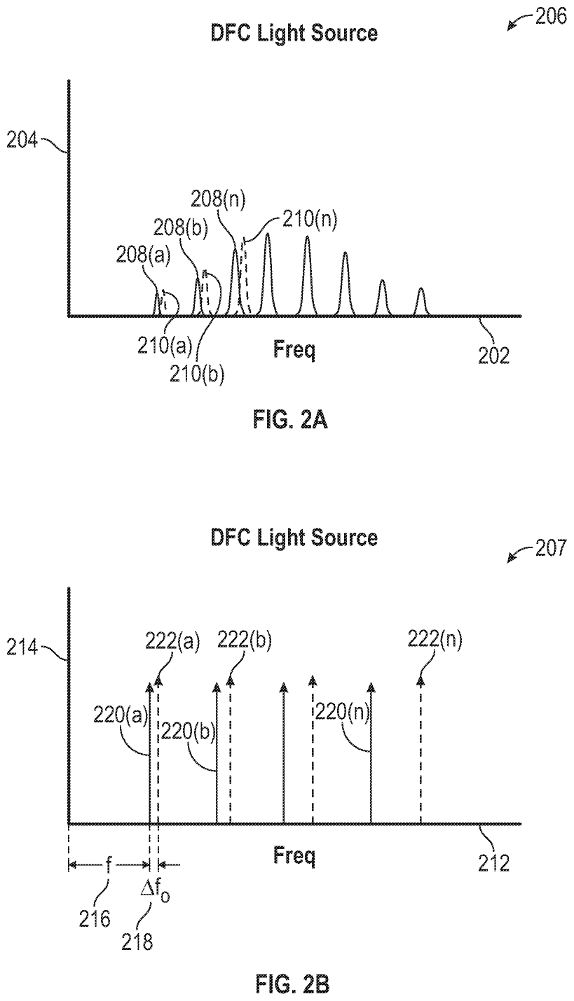

FIGS. 2A and 2B show two representations of a dual frequency comb. FIG. 2A shows the waveform representation, which includes some frequency spreading. FIG. 2B shows a vector representation of FIG. 2A, which does not show the frequency spreading.

FIG. 2A shows a representation of waveforms 206 of a dual frequency comb on x-axis 202 and y-axis 204. The first frequency comb wave is shown by 208(a) and the second frequency comb wave is shown as 210(a). Subsequent waves are shown as 208(b) . . . (n), where “n” is any suitable number, and 210(b) . . . (n), where “n” is any suitable number.

FIG. 2B shows a vector representation 207 of a dual frequency comb on x-axis 212 and y-axis 214. The first frequency comb vectors is shown by 220(a) . . . (n) and the second frequency comb vectors is shown as 222(a) . . . (n).

As shown in FIG. 2B, a measurement of the heterodyne RF signal at TIM at the single pixel detector (shown as element 120 in FIG. 1) provides information about the absorption of specific frequency at the dual frequency comb wavelengths.

A correlation measurement between the single pixel detector (120 herein) and multi-pixel detector (114 herein) provides a representation, which may be an image, a ghost image or electronic data that can be manipulated to generate an image, such as a ghost image.

A first frequency comb (for example, as shown by element 104(a) herein) waveform representation is shown by a solid line 208(a) in FIG. 2A and a vector representation is shown as solid line 220(a) in FIG. 2B. The first frequency comb vector 220(a) has a frequency f 216. A second frequency comb vector 222(a) (for example, as shown by element 104(b) herein), shown as a waveform in dashed line 210(a) . . . (n) in FIG. 2A and dashed lines 222(a) . . . (n) in FIG. 2B has a frequency of f+Δf₀. The dual comb vector pairs 220, 222 are separated by integer values of Δf₀ 218; ηΔf₀

Embodiments of the invention may be implemented by a processing device executing program code to perform a series of steps or execute an algorithm. The algorithm, or program code, may be stored on an electronic medium, non-transitory computer-readable medium, non-volatile electronic memory, remote memory location, RAM, ROM, EEPROM, or other suitable memory.

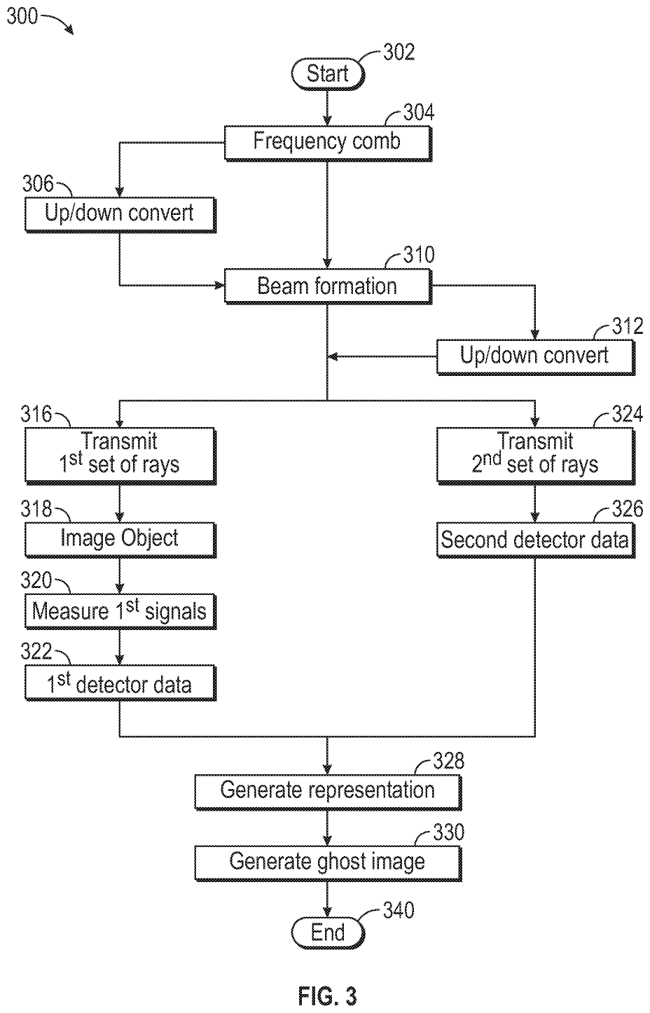

FIG. 3 shows a method 300 that may be used to implement an embodiment of the invention. The method 300 may be stored on an electronic storage medium, such as a non-transitory computer-readable medium, as described above, and may include a start (302). A frequency comb, such as a dual frequency comb, or a frequency comb that includes more that two frequency combs, is used as a light source (304). The signals from the frequency comb may be up converted and/or down converted (306) and then formed into a beam (310) with two components. This up/down conversion may be achieved by energy transfer sampling.

Alternatively, the signals from the frequency comb may be formed into a beam (310) with two components without being upconverted or down-converted.

Once the two beams have been formed (310) one or more signals of either or both beams may be up converted and/or down converted (312). This up/down conversion may be achieved by energy transfer sampling.

Alternatively, the two beams, once formed (310), can be used such that a first set of rays (316) and a second set of rays (324) are generated.

The first set of rays interface, or interact, with an object (318) and once having interacted with the object are measured (320). These measured signals are used to form a first set of data (322) which is collected at a first detector.

The second set of rays (324) are detected by a second detector and form second detector data (326). The second detector data does not interface or have exposure to the object that is under investigation. Indeed the second set of rays are independent of the object that is to be represented or imaged.

The first detector data (322) and second detector data (326) are processed to generate a representation of an object (328). The representation may be an electronic data set, stored signals, and/or pixel data. This representation may be used to generate an image, such as a ghost image (330). The process ends (340).

Down converting using energy sampling is described in U.S. Pat. No. 6,061,551, to David F. Sorrells et al. and U.S. Pat. No. 6,061,555 to Michael Bultman et al., both of which are hereby incorporated by reference in their entirety herein.

Energy Transfer Samplers (ETS) perform frequency down-conversion by using a portion of the energy from a continuous-time input signal over a discrete-time period to generate a frequency down-converted signal from the input signal energy. Because of the discrete-time sampling elements of Energy Transfer Samplers (ETS), the down-converted ETS output signal is created by sampling the continuous-time input signal at an aliasing rate (sampling at less than twice the highest frequency in the input signal). The highest frequency in the input signal used to determine the aliasing criteria is related to the Nyquist minimum bandwidth.

In the case where the Energy Transfer Sampler (ETS) storage element is a capacitor, a portion of the energy from the continuous-time input signal is stored (controlled charge) in the capacitive storage element in the form of charge (q) when the switch is closed (aperture period) and a portion of the stored charge (q) is transferred the output when the switch is open. Since only a portion of the charge stored in the capacitor is transferred to the load (controlled discharge) when the switch is open, the down-converted output waveform is generated over multiple charging/discharging sampling cycles which results in accumulating and integrating the energy in the capacitive storage element over multiple aperture periods. The process of charging, accumulating, integrating, and discharging the energy over multiple aperture periods provides a high energy to noise ratio down-converted output signal which is consistent with one of the principle advantages of Energy Transfer Sampling (ETS): Transferring non-negligible amounts of energy from a continuous-time input signal and generating the down-converted output signal from the transferred energy with a low noise figure, high signal to noise ratio (SNR), and a high Energy per bit to noise power (Eb)/(No).

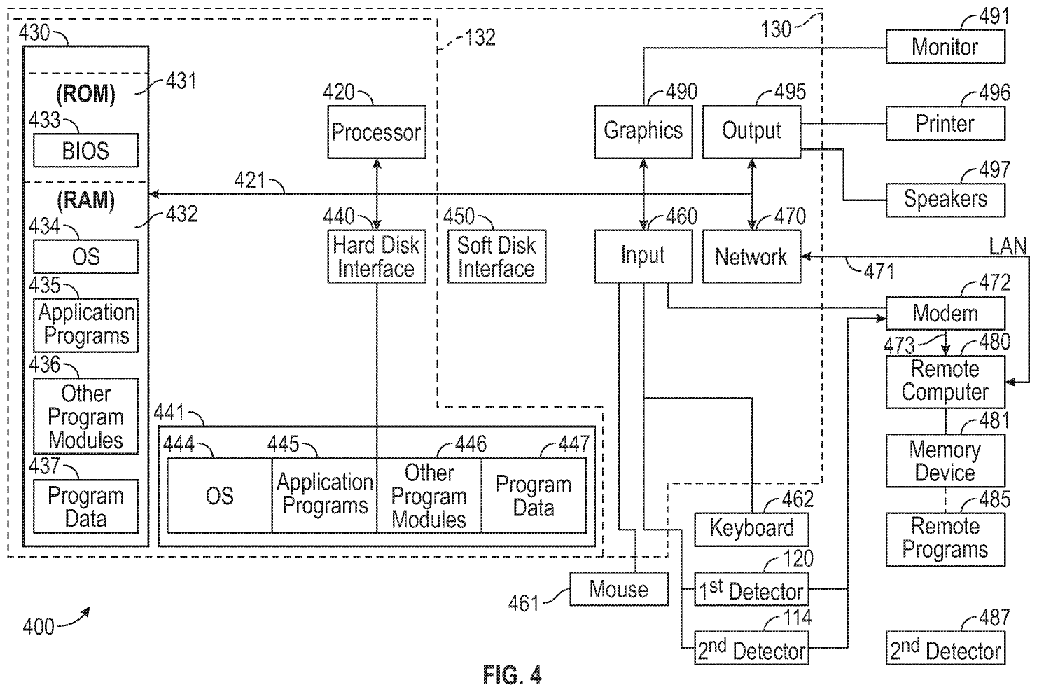

FIG. 4 illustrates a model computing device 400 in the form of a processor 130 and various peripheral and network components that can perform one or more computer-implemented steps, as described herein. Ghost processor 132 is shown as being part on the processor 130.

One or more of the embodiments may be performed on a computing device, or processor 130. A computing device may be understood to be any device having a processor, memory unit, input, and output. This may include, but is not intended to be limited to, cellular phones, smart phones, tablet computers, laptop computers, desktop computers, personal digital assistants, graphical processing units, field programmable gate arrays, etc. Components of the computer may include, but are not limited to, a processing unit 420, a system memory 430, and a system bus 421 that couples various system components including the system memory 430 to the processing unit 420.

The first detector 120 and the second detector 114 are operatively coupled to the processor 130 by input to input 460 as well as, in a network environment, through modem 472

The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

Computer 400 typically includes a variety of computer readable media. Computer readable media can be any available media that can be accessed by a computer 400 and includes both volatile and nonvolatile media, removable and non-removable media. By way of example, and not limitation, computer readable media may include computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer, or processor, 130.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 430 includes computer storage media in the form of volatile and/or nonvolatile memory such as read only memory (ROM) 431 and random-access memory (RAM) 432. A basic input/output system 433 (BIOS), containing the basic routines that help to transfer information between elements within computer 130, such as during start-up, is typically stored in ROM 431. RAM 432 typically contains data and/or program modules that are immediately accessible to and/or presently being operated on by processing unit 420. By way of example, and not limitation, FIG. 4 illustrates an operating system (OS) 434, application programs 435, other program modules 436, and program data 437.

The computer 130 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive that reads from or writes to a removable, nonvolatile magnetic disk. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440. Soft disk interface 450 is also shown.

The drives, and their associated computer storage media discussed above and illustrated in FIG. 4, provide storage of computer readable instructions, data structures, program modules and other data for the computer 130. In FIG. 4, for example, hard disk drive 441 is illustrated as storing an OS 444, application programs 445, other program modules 446, and program data 447. Note that these components can either be the same as or different from OS 434, application programs 435, other program modules 436, and program data 437.

A user may enter commands and information into the computer 130 through input devices such as a keyboard 462 and cursor control device 461, commonly referred to as a mouse, trackball or touch pad.

Other input devices (not shown) may include a microphone, joystick, game pad, satellite dish, scanner, or the like. These and other input devices are often connected to the processing unit 420 through a user input interface 460 that is coupled to the system bus but may be connected by other interface and bus structures, such as a parallel port, game port or a universal serial bus (USB). A monitor 491 or other type of display device is also connected to the system bus 421 via an interface, such as a graphics controller 490. In addition to the monitor, computers may also include other peripheral output devices such as speakers 497 and printer 496, which may be connected through an output peripheral interface 495.

The computer 130 may operate in a networked environment using logical connections to one or more remote computers, such as a remote computer 480. The remote computer 480 may be a personal computer, a server, a router, a network PC, a peer device or other common network node, and typically includes many or all the elements described above relative to the computer 130, although only a memory storage device 481 has been illustrated in FIG. 4. The logical connections depicted in FIG. 4 include a local area network (LAN) 471 and a wide area network (WAN) 473 but may also include other networks. Such networking environments are commonplace in offices, enterprise-wide computer networks, intranets and the Internet.

When used in a LAN networking environment, the computer 130 is connected to the LAN 471 through a network interface or adapter 470. When used in a WAN networking environment, the computer 130 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481.

The communications connections 470 and 472 allow the device to communicate with other devices. The communications connections 470 and 472 are examples of communication media. The communication media typically embodies computer readable instructions, data structures, program modules or other data in a modulated data signal such as a carrier wave or other transport mechanism and includes any information delivery media.

A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

This invention is directed to generating a representation of an object. The representation, while may comprise a ghost image, is not restricted to a ghost image and may include any electronic, data or other collection of information that may be manipulated to generate an image of the object in a desired format.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if desired, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wire line, optical fiber cable, RF, etc.

Computer program code for carrying out operations may be written in any combination of one or more programming languages, including an object-oriented programming language such as Java, Smalltalk, C++, C# or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present embodiments are described herein with reference to flowchart illustrations and/or block diagrams of methods, apparatus, systems and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer, or other programmable data processing apparatus, create means for implementing the functions/acts specified in the flowchart and/or block diagram block or blocks. These computer program instructions may also be stored in a computer-readable medium that can direct a computer or other programmable data processing apparatus, to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer, or other programmable apparatus to produce a computer-implemented process such that the instructions which execute on the computer or other programmable apparatus, provide processes for implementing the functions/acts specified in the flowchart and/or block diagram block or blocks.

Various embodiments are described herein and include apparatus and methods.

As will be appreciated by one skilled in the art, the invention may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments may take the form of a computer program product embodied in any tangible medium of expression having computer-usable program code embodied in the medium.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general disclosed concepts.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope. In addition, many modifications may be made to adapt a particular situation or material to the teachings without departing from the essential scope thereof.

Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

1. An apparatus comprising:
a light source configured to provide a first set of light rays to a first detector and a second set of light rays to a second detector;
the first detector configured to measure signals that result from the first set of light rays interfacing with an object and generate first detector data; and
the second detector configured to receive the second set of light rays that are independent from the object and generate second detector data,
where the first detector data and the second detector data are utilized to generate a representation of the object.

2. The apparatus as claimed in claim 1, where the second detector data is raster scanned.

3. The apparatus as claimed in claim 1, where the representation of the object is a spatial image.

4. The apparatus as claimed in claim 1, where the representation of the object includes spectroscopic information.

5. The apparatus as claimed in claim 1, where the first detector includes a multi-pixel detector.

6. The apparatus as claimed in claim 1, where the second detector includes a single pixel detector.

7. The apparatus as claimed in claim 1, further comprising:
a processor, operatively coupled to the first detector and the second detector, to manipulate the first detector data and the second detector data to generate the representation of the object.

8. The apparatus as claimed in claim 7, where the manipulation includes correlation of the first detector data and the second detector data.

9. The apparatus as claimed in claim 1, where the object is a chemical agent or a biological agent.

10. The apparatus as claimed in claim 1, where the first detector data is generated using a Fourier transform.

11. The apparatus as claimed in claim 1, where the first set of light rays are up-converted or down-converted.

12. The apparatus as claimed in claim 1, where the light source is a dual frequency comb.

13. A method comprising:
providing a first set of light rays;
providing a second set of light rays;
measuring signals, at a first detector, that result from the first set of light rays interfacing with an object;
generating first detector data based on the measured signals at the first detector;
measuring signals, at a second detector, from the second set of light rays that are independent from the object;
generating second detector data based on measured signals at the second detector; and
generating a representation of the object based on the first detector data and the second detector data.

14. The method as claimed in claim 13, further comprising: raster scanning the second detector data.

15. The method as claimed in claim 13, where the generating the representation of the object generates a spatial image.

16. The method as claimed in claim 13, where the representation of the object includes spectroscopic information.

17. The method as claimed in claim 13, further comprising: correlating the first detector data and the second detector data.

18. The method as claimed in claim 13, further comprising: generating the first detector data using a Fourier transform.

19. The method as claimed in claim 13, further comprising: up-converting or down-converting the first set of light rays.

20. A system comprising:
a processor; and
a memory operatively coupled to the processor, the memory adapted to store instructions to:
provide a first set of light rays;
provide a second set of light rays;
measure first signals that result from the first set of light rays interfacing with an object;
generate first data based on the first measured signals;
measure second signals from the second set of light rays that are independent from the object;
generate second data based on the second measured signals; and
generate a representation of the object based on the first data and the second data.
